(19) United States
(12) Patent Application Publication
(10) Pub. No.: US 2004/0174365 A1
(43) Pub. Date: Sep. 9, 2004

(54) Method and system for computer animation

(76) Inventor: Gil Bub, Brooklyn, NY (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/740,753

(22) Filed: Dec. 22, 2003

Related U.S. Application Data
(60) Provisional application No. 60/435,912, filed on Dec. 24, 2002.

(51) Int. Cl. G06T 15/70

(52) U.S. Cl. 345/473

(57) ABSTRACT

Methods and systems in accordance with the present invention provide computer animation in which drawing lines or marks are erased after a predetermined time interval. When the lines or marks are automatically erased after a set interval, animations may be created with relatively little effort. Methods and systems in accordance with the present invention provide an easy, intuitive way to create animations by recording drawing events in sequence, and playing back these events at a defined rate while erasing old events after a predetermined interval. The persistence interval, which can be defined, for example, in time or by a function of the relative order the line was drawn (“line drawn index”), and the playback rate may be defined by the creator of the animation for each drawing event. The result of this process is a dynamically changing drawing which can be replayed as an animation.

### RELATED APPLICATION

This application is related to, and claims priority to U.S. Provisional Patent Application Serial No. 60/435,912, entitled, “Method for Creating Animated Drawings by Recording Drawing Events and Erasing Events After a Defined Interval,” which is incorporated by reference herein.

### BACKGROUND

1. Field of the Invention

The present invention generally relates to data processing systems. In particular, the present invention generally relates to a method and system for computer animation.

2. Background

Computer animation is being used increasingly in today's computing world. The conventional frame-based approach to animation is typically based on creating complete static frames which are displayed and erased in sequence at a set rapid interval. For example, a complete frame is displayed, and then a different frame is displayed. Although conventional frame-based animation produces convincing animations, there are at least three disadvantages. First, conventional frame-based animation is labor intensive. Each frame, or at least part of each frame, e.g., the foreground, must be redrawn by the artist in order to convey motion. The illusion of motion is created when frames are played back rapidly in sequence. Second, the process of creating a conventional frame-based animation is typically unnatural for artists. The artist creates each static frame while keeping in mind the relative timing of each drawing in order to create a visually convincing final result. In this sense, the animator does not directly draw an animated drawing. Third, some information created during the act of drawing the frame is lost as each frame is static. For example, a line drawn left to right is identical to a line drawn right to left in a static frame. This information could be used to convey motion but is lost.

One conventional approach for reducing the amount of labor involved in creating frame-based animation is a process called “tweening.” Tweening is a process that uses a computer algorithm to fill in frames between two static frames by morphing the scene. A problem with this approach is that the artist is not an active participant in the morphing process. The artist does not draw the images, rather the algorithm does. As a result, tweening produces animations that appear (and are) computer-generated.

Another conventional animation technique includes sprite-based animation which involves having defined “sprites,” i.e., static or animated drawings, which move with set paths over time in space. A static drawing is moved by a computer algorithm along a spatial path over a static background over a set period of time. The sprite may be given some animated attributes to enhance the animation effect. Unfortunately, the result often lacks a hand-drawn natural look. One reason sprite-based animation may look artificial is that the artist does not use his or her drawing skills to animate the sprite.

Creating animations using either of these conventional techniques does not take advantage of the natural process of drawing: when creating a normal static drawing, the creator typically places brush strokes on the substrate in sequence. Conventional drawing techniques also suffer from the problem that creating a composition comprises a set of marks (lines, points, brush strokes, etc.) that gradually fill a set space. The result of conventional drawing techniques is typically a static, bounded-in-space representation that depends on the artist's skill in order to convey a sense of movement and time. Therefore, it is desirable to overcome these and related problems.

### BRIEF DESCRIPTION OF THE DRAWINGS

FIG. 1 depicts an exemplary data processing system suitable for use in accordance with methods and systems consistent with the present invention.

FIG. 2 depicts the steps in a method for adding a line or drawing event in accordance with methods and systems consistent with the present invention.

FIG. 3 depicts the steps in a method for displaying lines or other drawing events while adding the lines in accordance with methods and systems consistent with the present invention.

FIG. 4 depicts the steps in an exemplary method for displaying an animation in accordance with methods and systems consistent with the present invention.

FIG. 5 depicts an exemplary illustration of a graphical user interface main window in accordance with methods and systems consistent with the present invention.

FIGS. 6a-c depict an exemplary illustration of a drawing of characters in accordance with methods and systems consistent with the present invention.

FIGS. 7a-c depict an exemplary illustration of a drawing of a stick figure in accordance with methods and systems consistent with the present invention.

FIGS. 8a-b depict an exemplary illustration of a drawing of fading characters in accordance with methods and systems consistent with the present invention

FIGS. 9a-b depict an exemplary illustration of a drawing of a square being transformed and characters in accordance with methods and systems consistent with the present invention.

### SUMMARY

Method and systems in accordance with the present invention provide computer animation in which drawing lines or marks are erased after a predetermined time interval. When the lines or marks are automatically erased after a set interval, animations may be created with relatively little effort. Methods and systems in accordance with the present invention provide an easy, intuitive way to create animations by recording drawing events in sequence, and playing back these events at a defined rate while erasing old events after a predetermined interval.

A method in a data processing system is provided comprising the steps of receiving an indication of a drawing event, and assigning a duration to the drawing event. The method further comprises displaying the drawing event, and erasing the displayed drawing event after the duration is expired.

In addition, a data processing system is provided comprising a memory comprising a program that receives an indication of a drawing event, assigns a duration to the drawing event, displays the drawing event, and erases the displayed drawing event after the duration is expired. The data processing system further comprises a processor for running the program.

Furthermore, a computer-readable medium is provided containing instructions for controlling a data processing system to perform a method comprising the steps of receiving an indication of a drawing event, and assigning a duration to the drawing event. The method further comprises displaying the drawing event, and erasing the displayed drawing event after the duration is expired.

### DETAILED DESCRIPTION

Method and systems in accordance with the present invention provide computer animation in which drawing lines or marks are erased after a predetermined time interval. When the lines or marks are automatically erased after a set interval, animations may be created with relatively little effort. Methods and systems in accordance with the present invention provide an easy, intuitive way to create animations by recording drawing events in sequence, and playing back these events at a defined rate while erasing old events after a predetermined interval. The persistence interval, which can be defined, for example, in time or by a function of the relative order the line was drawn (“line drawn index”), and the playback rate may be defined by the creator of the animation for each drawing event. The result of this process is a dynamically changing drawing which can be replayed as an animation.

Methods and systems in accordance with the present invention may record input drawing events, e.g., lines, points, marks, brushstrokes, etc., and display the drawing events on the screen. While the user draws, the system erases old drawing events after a time has expired. This may cause the system to erase old lines in the time order they were drawn. The erasing of drawing events may occur after an interval defined, for example, by the user. The interval can be defined in time, e.g., a set number of seconds after the line was originally drawn, or by line sequence, e.g., erase the line after a set number of new lines have been added to the drawing. Alternatively, methods and systems in accordance with the present invention may randomly assign erase times, possibly, within user-defined constraints. Additionally, other variations for erasing drawing events may be used.

The user may define playback times for each line. The playback rate controls how long the system pauses before drawing the next line. In one implementation, this variable does not come into play when the user is drawing, but rather when the user plays back the drawing as an animation. As an example, imagine that the user draws a sketch that consists of 100 line segments. If the playback rate was set at 10 milliseconds for each line, the sketch would take 1000 milliseconds (1 second) to play as an animation. The system may ignore the playback rate when the user is drawing; the system may draw the sketch as fast or as slow as the user is drawing it. The user may predefine a playback rate and change it a few times while creating the drawing.

The user may also define the persistence of the lines a few times in the drawing. Persistence controls the erase time of the line. When complete, the system replays the drawing using the defined playback time for each line, and the result is an animation. Simple animations can be created by defining a single playback rate and line persistence for the entire animation. More complex animations can be created by varying line persistence and playback rates frequently during the creation of the animation. Additional variations include, but are not limited to: (1) changing the order of drawn lines within bounds set by the user to enhance the animation effect, (2) fading lines or changing color instead of erasing, (3) color filling polygons defined by the lines drawn using user-defined or algorithmically chosen color values, and (4) facilitating viewer interaction by adding links and buttons that zoom, pan, scale, and replay the animation or load different documents or files onto the viewing area.

In one implementation, the system may be utilized as a dynamic drawing tool. The user can replay the animation of the drawing sequence and print out static images from points along the time line. These images can also be saved and used as starting points for subsequent drawings.

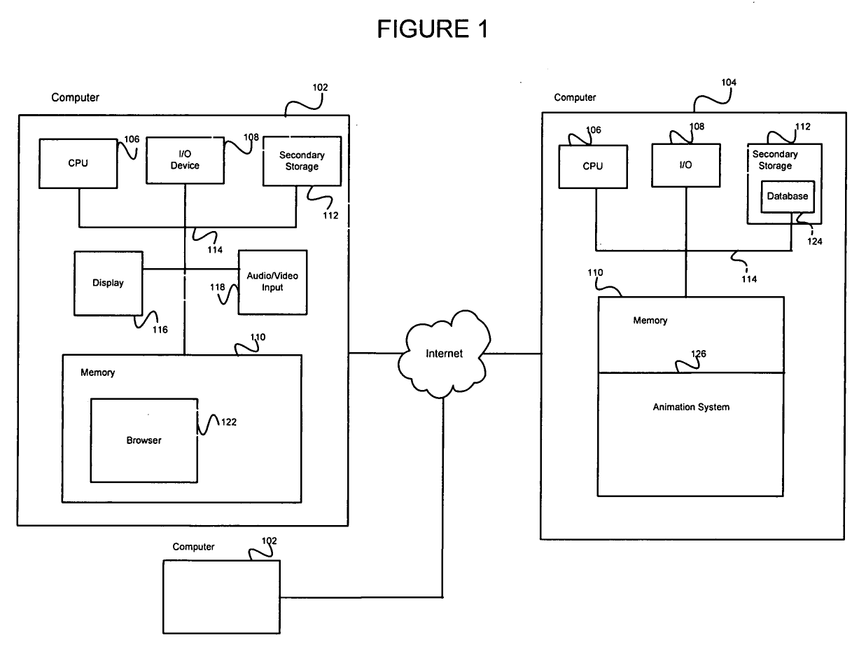

FIG. 1 depicts an exemplary data processing system suitable for use in accordance with methods and systems consistent with the present invention. Methods and systems in accordance with the present invention may be implemented as software or hardware or any combination thereof. FIG. 1 shows two computers 102 and a computer 104 connected to a network such as the Internet, and either computer may represent any kind of data processing device, such as a general-purpose data processing device, a personal computer, a plurality of interconnected data processing devices, a mobile computing device, a personal data organizer, a mobile communication device including mobile telephones or similar devices. The computers 102 and computer 104 may represent computers in a distributed environment, such as on the Internet. There may also be more computers than shown on the figure. Also, methods and systems in accordance with the present invention may be implemented on a single computer such as computer 102.

A computer 102 includes a central processing unit (“CPU”) 106 and an input-output (“I/O”) unit 108, such as a mouse or keyboard. The I/O unit 108 may include a drawing tool such as a drawing tablet, hand held pen-based personal digital assistant, pen-based computer, pressure sensitive screen, etc. Any other input device may be used. The I/O unit 108 may receive any recordable input. It may receive spatial coordinates but may also receive pressure information which can be mapped to variables in the system including, for example, thickness, line brightness, as well as line persistence. Drawing event input may also be in more than two dimensions. The input may be vector-based, i.e., a series of lines, and can be arbitrarily scaled to a different size with no pixelization effects.

Computer 102 includes a memory 110 such as a random access memory (“RAM”) or other dynamic storage device for storing information and instructions to be executed by the CPU. Memory 110 may store an animation system 126 described below. The computer 102 also includes a secondary storage device such as a magnetic disk or optical disk that may communicate with each other via a bus 114 or other communication mechanism. The computer 102 may also include a display 116 such as such as a cathode ray tube (“CRT”) or LCD monitor, and an audio/video input 118 such as a webcam and/or microphone. The display may display input from more than one user.

Although aspects of methods and systems consistent with the present invention are described as being stored in memory 110, one having skill in the art will appreciate that all or part of methods and systems consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of the data processing system are described, one skilled in the art will appreciate that a data processing system suitable for use with methods, systems, and articles of manufacture consistent with the present invention may comprise additional or different components. The computer 102 may include a human user or may include a user agent. The term “user” may refer to a human user, software, hardware or other entity using the system.

As shown, the memory 110 in the computer 102 may include a browser 122 which is an application 122 that is typically any program or group of application programs allowing convenient browsing through information or data available in distributed environments, such as the Internet or any other network including local area networks. A browser application 122 generally allows viewing, downloading of data and transmission of data between data processing devices. The browser 122 may also be other kinds of applications and may permit the transmission or viewing of remote drawings.

Additionally, although shown on the computer 102 in the memory 110, components may reside elsewhere, such as in the secondary storage 112, or on another computer, such as another computer 102. Furthermore, these components may be hardware or software whereas embodiments in accordance with the present invention are not limited to any specific combination of hardware and/or software.

FIG. 1 also depicts a computer 104 that includes a CPU 106, an I/O unit 108, a memory 110, and a secondary storage device 112 having a database 124 that communicate with each other via a bus 114. The memory 110 may store an animation system 126 which manages and implements drawing processes in accordance with methods and systems consistent with the present invention. As mentioned, the animation system 126 may also reside on the computer 102. In one implementation, the drawing process is implemented as described in detail below. The database 124 may store information pertaining to drawings, line information, data regarding lines (described below), associated video files, audio files, etc. Animations may be saved in any suitable file format such as .avi, .mpg, .swf, etc. The database 124 may also reside elsewhere, such as in memory 110. The computer 104 may also have many of the components mentioned in conjunction with the computer 102. There may be many computers 104 working in conjunction with one another. The animation system 126 may be implemented in any way, in software or hardware or a combination thereof, and may be distributed among many computers. It may be represented by any number of components, processes, threads, etc.

The computer 102 and computer 104 may communicate directly or over networks, and may communicate via wired and/or wireless connections or any other method of communication. Communication may be done through any communication protocol, including known and yet to be developed communication protocols. The network may comprise many more computers 102 and computers 104 than those shown on the figure, and the computers may also have additional or different components than those shown.

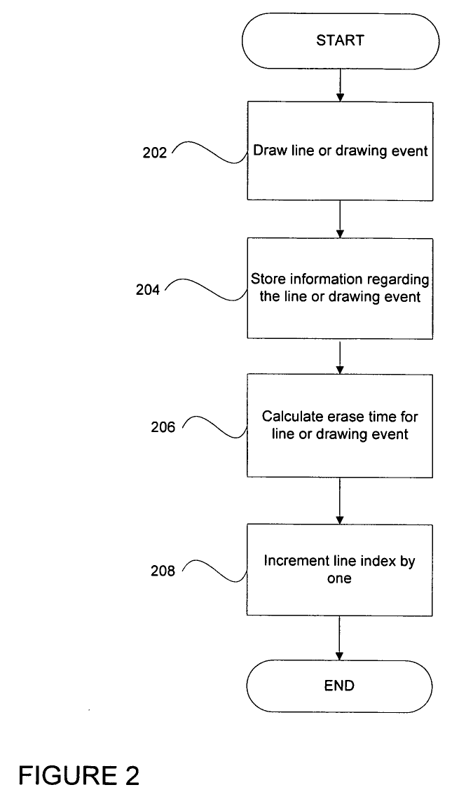

FIG. 2 depicts the steps in an exemplary method for adding a line or drawing event in accordance with methods and systems consistent with the present invention. These steps may be implemented each time a user presses down or drags on the drawing area with a mouse or drawing tool. The user may pre-select the line color (Color), thickness (Thickness), replay rate (Rate), and duration (Duration) and may sketch by dragging the mouse or other drawing tool. First, a user draws a line or any drawing event (step 202). Information regarding the line or drawing event is stored in memory (step 204). When the user drags the drawing tool from point A to point B, in one implementation, points on the line or drawing event are recorded to memory and saved with user pre-selected values for the line's color, thickness and replay rate. An erase time (EraseTime) for this new line is calculated based on the present line index (DrawTime), i.e., line number counter, and a pre-selected value for duration, and saved with the data for this new line (step 206). In one implementation, erase time is calculated by EraseTime=DrawTime+Duration. In addition, each line may have a visibility variable (Visibility), and it may be set to true for a newly drawn line.

In one implementation, line objects are stored sequentially in an array or vector, and each line can be referred to by its index (DrawTime). When the user drags the drawing tool 108 from point A to point B, the line index (DrawTime) is incremented by one (step 208).

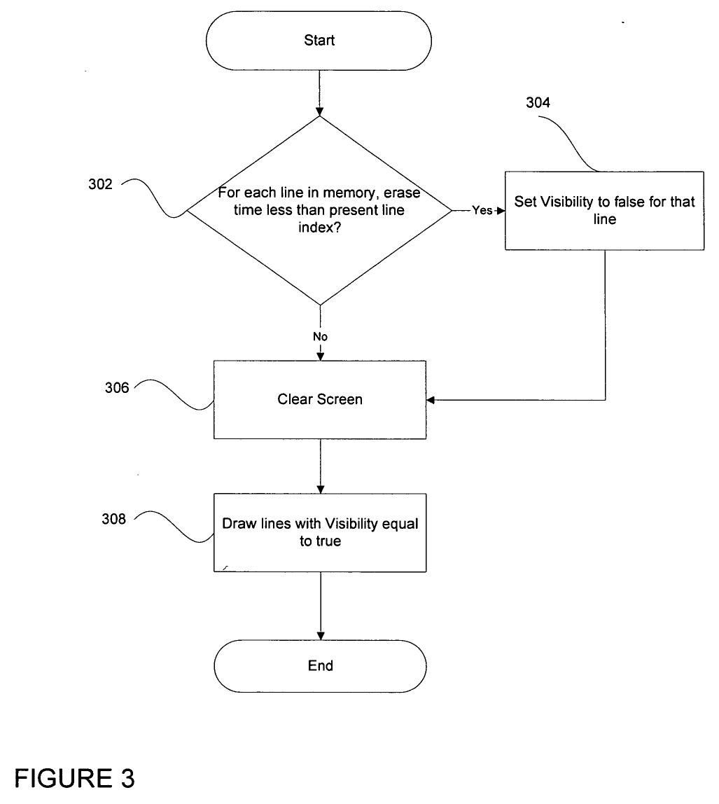

FIG. 3 depicts steps in an exemplary method for displaying lines or other drawing events while adding the lines in accordance with methods and systems consistent with the present invention. As each line is added to memory, the new information may be displayed using this exemplary method. For each line, the animation system 126 checks if the pre-calculated erase time (EraseTime) is less than the present line index (DrawTime) (step 302). If it is, its Visibility is set to false (step 304). The animation system 126 then causes lines with Visibility=false to be erased and ensures that visible lines are shown on the screen. In one implementation, the screen is cleared (step 306), and lines having Visibility=true are drawn (step 308). In another implementation, the animation system 126 erases only lines that have recently been made invisible, and draws only newly created lines. Lines are drawn using the saved values of Color and Thickness. The following pseudo code illustrates this exemplary process in accordance with FIGS. 2 and 3:

```
Increment DrawTime variable;
Assign line EraseTime, Color, Thickness, Rate;
Store line in memory; /*a vector of line objects*/
Set Visibility=true;
For each line in memory {
      If (EraseTime<DrawTime) set Visibility=false;
      }
Clear viewing area;
For each line in memory{
      Draw if Visibility=true; /*render on screen*/
      }
```

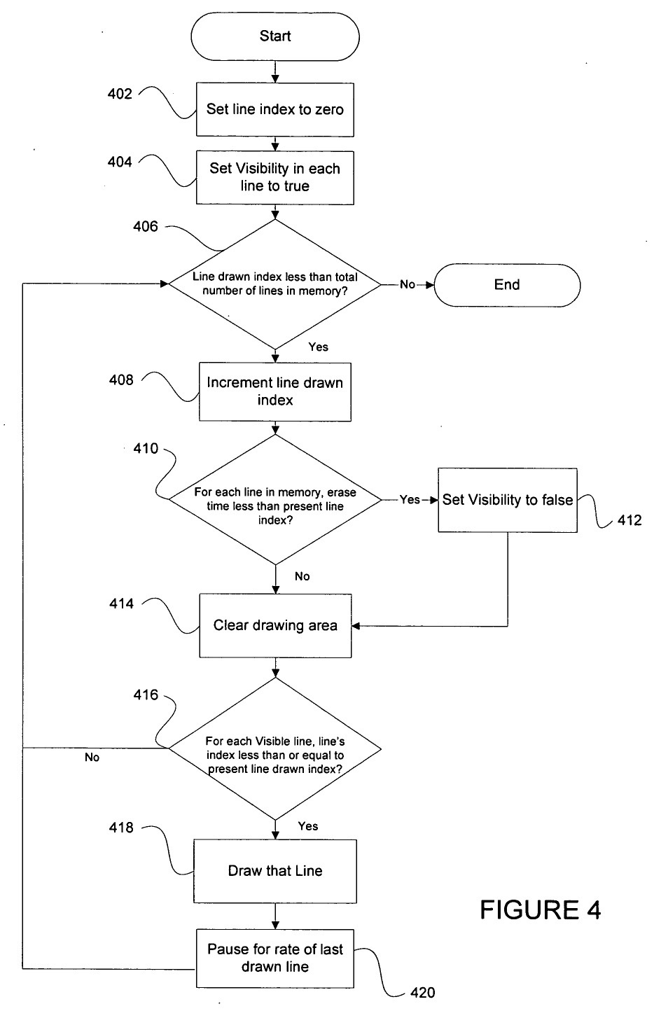

FIG. 4 depicts steps in an exemplary method for displaying an animation in accordance with methods and systems consistent with the present invention. This exemplary method may replay an animation stored in accordance with the previously described process. For replaying the animation, the line drawn index is set to zero (DrawTime=0) (step 402). The visibility variable (Visibility) for each line in memory is set to true (step 404).

Next, a loop is initiated. During this loop, while the line drawn index is less than the total number of lines in memory 110 (step 406), the animation system 126 increments the line drawn index (step 408). Next, for each line in memory 110, the animation system 126 sets the Visibility of the line to false (step 412) if the erase time (EraseTime) is less than the line drawn index (step 410). The animation system 126 then clears the drawing area (step 414). The animation system 126 draws each visible line, i.e., Visibility=true (step 418), if the line's index (DrawTime) is less than or equal to the present line drawn index (step 416). Finally, the animation system 126 pauses for a length of time equal to the saved value of Rate for the last line drawn (step 420). This loop may be repeated (by going back to incrementing the line drawn index) until the line drawn index is equal to the total number of lines in memory 110.

The following pseudo code illustrates an exemption method in accordance with FIG. 4:

```
Set DrawTime back to 0;
Set Visibility for each line in memory to true;
While (DrawTime<NumberOfLines){/*for every line in memory*/
      Increment DrawTime variable;
      For each line in memory {
      If (EraseTime<DrawTime) set Visibility=false;
      }
      Clear Viewing area;
      For each line in memory{
            If (LineNumber<=DrawTime)
                  Draw if Visibility=true; /*render on screen*/
      }
      Pause for a length of time = Rate of the last line drawn.
}
```

In one embodiment, instead of incrementing the line drawn index by one, it is incremented by a larger value so that the total number of new lines drawn have a cumulative rate that is close to a visually acceptable frame rate. For example, if the user selected Rate=10 ms, then the animation system 126 would increment DrawTime by 5 in order to have the screen refresh every 50 ms. Complex drawings may have lines with different values for Rate, so DrawTime may be incremented by a value that is calculated dynamically. In addition, the screen may also be updated so that it does not clear and completely redraw the screen with every increment of DrawTime, but, in one implementation, rather draws only newly visible lines, and erases lines that have recently had their Visibility set to false.

In the some of the above examples, the line drawn index (DrawTime) keeps track of both the location of the line in the array of lines, as well as the time that it is drawn. In another embodiment, a separate time variable (Time) is compared to variables that control when lines become visible (VisibleAtTime) and are erased (EraseAtTime). Using a separate time variable (Time) may simplify the process if more than one array of lines are used to draw the image. For example, more than one array of lines may be used if there are separate layers.

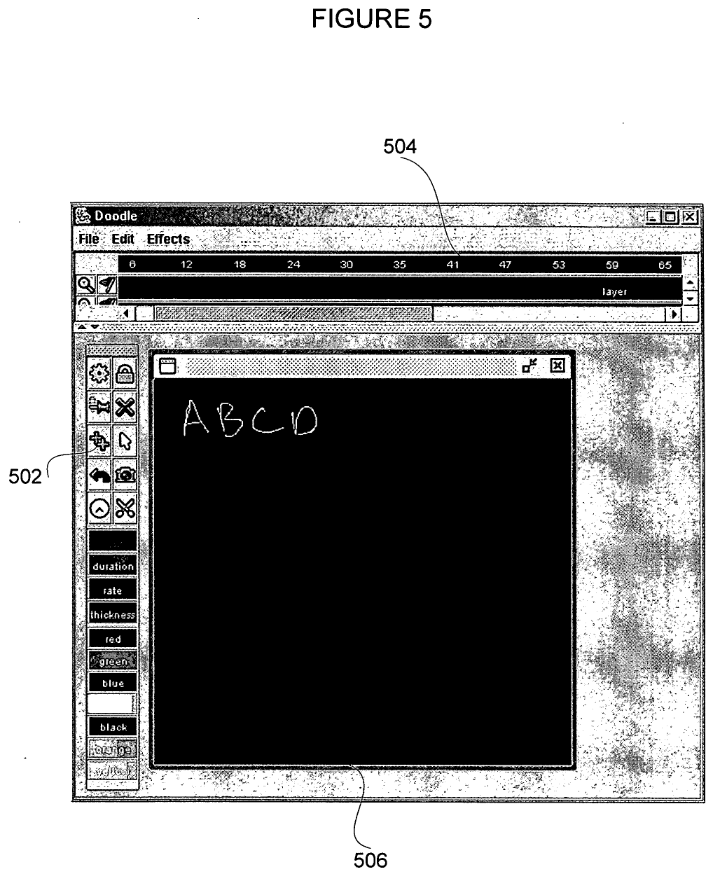

FIG. 5 depicts an exemplary illustration of a graphical user interface main window in accordance with methods and systems consistent with the present invention. It may include a toolbar 502, a time-line window 504 and a main drawing area 506. This exemplary user interface may be implemented in other ways. FIGS. 5-9, described below, depict the main drawing area 506.

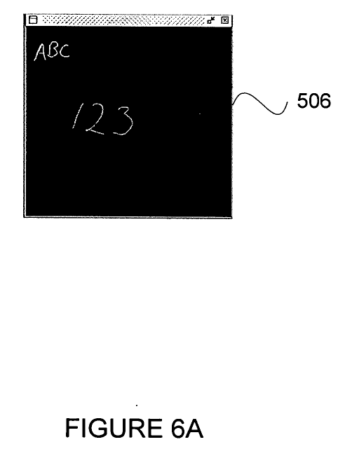

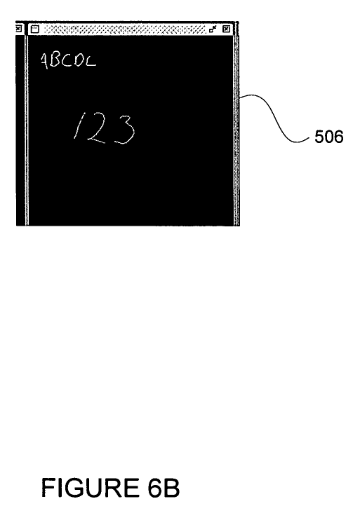

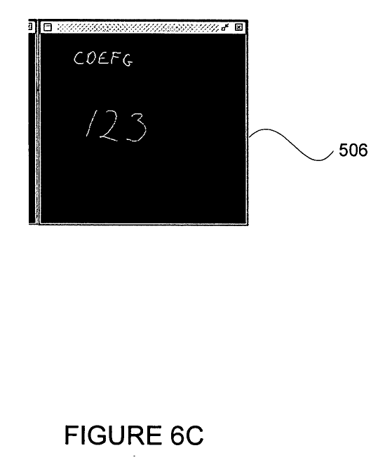

FIGS. 6a-c depict an exemplary illustration of a drawing of characters in accordance with methods and systems consistent with the present invention. In this example, the user has used the controls in the graphical user interface to set the duration of the line to 1000. The user then drew the numbers 1, 2 and 3 as shown. The user then used the controls to set the duration to 100. The user then drew some letters of the alphabet. FIG. 6a shows the first three letters drawn (A, B and C). FIG. 6b shows that the beginning of the line (used to draw the letter A) starts to erase as the letters D and part of E are drawn. In FIG. 6c, the letters A and B are erased as the letters F and G are drawn. During this exemplary process, the numbers remain because their duration setting is high.

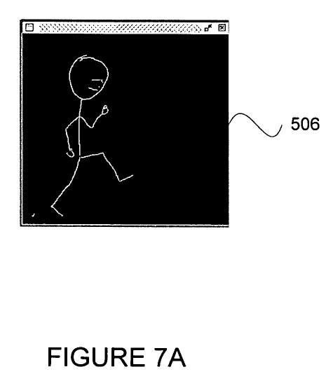

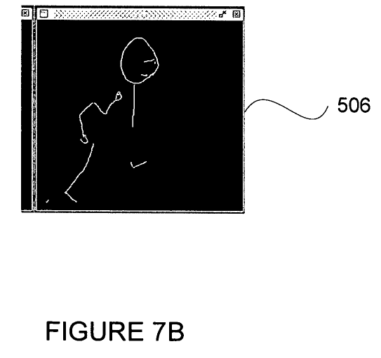

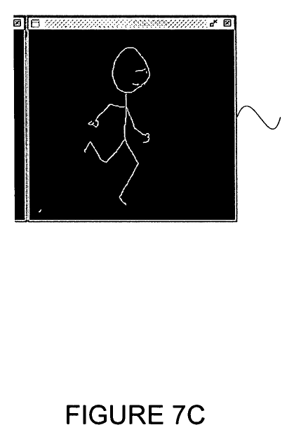

FIGS. 7a-c depict an exemplary illustration of a drawing of a stick figure in accordance with methods and systems consistent with the present invention. This shows an example of a way to create an animation. In this example, a human stick figure is drawn to take a single step. Before the figure in FIG. 7a is drawn, the animation system 126 is instructed (via a user interface element such as a dial or dialog box for example) that the duration of the line is 400. This allows the user to sketch the figure in the FIG. 7a before any of the lines erase. Once the figure in FIG. 7a is complete, the user proceeds to draw the figure in the FIG. 7c. As a consequence of duration setting, the figure as drawn in FIG. 7a starts erasing while the second figure (FIG. 7c) is being drawn. this process is depicted in FIG. 7b. In one implementation, the user does not activate any controls or change any settings during this process. The user sees the first drawing being erased as the user draws the second drawing.

The drawings may be replayed at a fast rate to give an impression of movement. One of the visual features of animations in accordance with methods and system consistent with the present invention is that transitions between positions (FIGS. 7a and 7c) are filled with on-screen activity created by the rapid erasure and drawing of lines. This on-screen activity generates a fluid sense of movement for the viewer and helps guide the eye between two positions. This contrasts with a frame-based approach to creating animations, which would require several additional intermediate drawings between FIGS. 7a and 7c to convey a sense of motion.

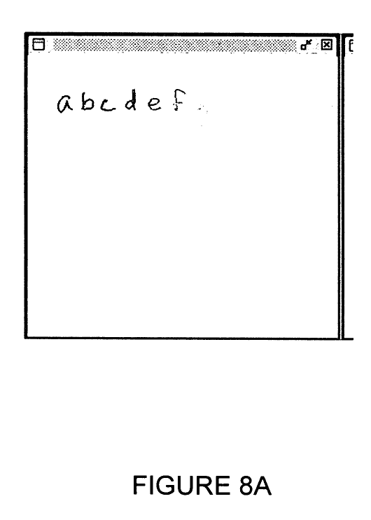

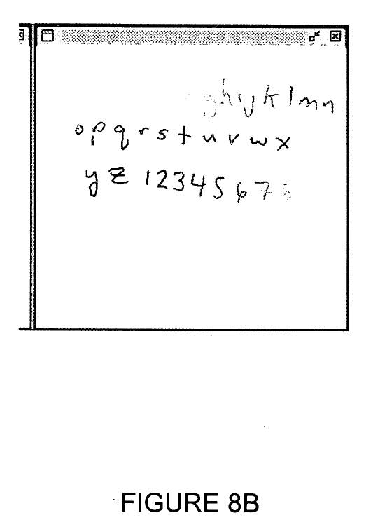

FIGS. 8a-b depict an exemplary illustration of a drawing of fading characters in accordance with methods and systems consistent with the present invention. In addition to erasing the lines, the animation system 126 can also cause the lines to fade in and/or out over a predefined interval. In FIGS. 8a-b, the duration of the line is set to 1000 and the user sequentially writes the letters of the alphabet followed by the numbers 1 through 9. In addition to erasing the line, the system 126 incrementally decreases the alpha level (from 1 to 0) for lines close to expiring (in this case, lines within 300 units of their expire time are faded out). The animation system 126 increases an alpha level (from 0 to 1) for lines recently drawn (in this case, lines that have been displayed for less than 100 units are faded in).

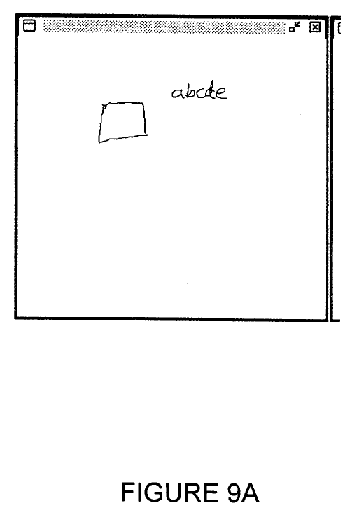

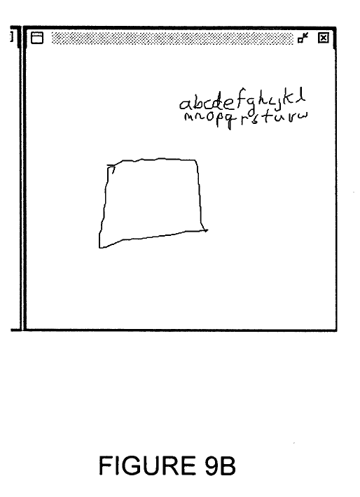

FIGS. 9a-b depict an exemplary illustration of a drawing of a square being transformed and characters in accordance with methods and systems consistent with the present invention. In this example, the use of multiple layers, as well as a continuous transform are demonstrated. In FIG. 9a, the user draws a square shape in layer 1, then sequentially draws the letters of the alphabet in layer 2. The animation system 126 applies a continuous transform to layer 1. As shown in FIG. 9b, as the artist continues to draw the letters of the alphabet in layer 2, the square shape in layer 1 is expanded and moved to the bottom right of the draw area.

In one implementation, the playback rate can be set by the user or set programmatically. The user can draw a sketch and then cause the lines in that sketch to play back within a certain time frame. For example, the user could draw a hundred line segments and the program may play back those lines within 200 milliseconds. The playback rate for each line segment would then be algorithmically set to 2 milliseconds.

When the playback rate is set algorithmically, the animation system 126 draws and erases lines within a certain time frame (the frame rate). The system dynamically changes the replay rate variable and the erase time variable so that parts of the drawing are displayed and erased within a certain predefined frame rate. The user interface may include a frame advance control (a button, toolbar, menu item or similar graphical user interface element) that allows the user to define time points when a new frame is defined. For example, the user may preset the frame rate to 200 milliseconds, draw a sketch that consists of 1000 line segments, and activate the frame advance control three times during the sketching process first after the 200th line segment is drawn, second after the 700th line segment is drawn, and third after the 1000th line segment is drawn. The system then sets the replay rate so that the first 200 line segments have a replay rate of 1 millisecond each (200*1 millisecond=200 millisecond frame rate), the next 500 line segments have a replay rate of 0.4 millisecond (500*0.4 millisecond=200 millisecond frame rate), and the next 300 lines have a replay rate of 0.667 milliseconds (300*0.667=200 millisecond frame rate). The program may also algorithmically set the erase time of each line so that the first 200 line segments are erased in sequence by the time the next 500 lines are drawn, and the next 500 line segments are erased in sequence by the time that the last 300 line segments are drawn. The overall effect of these algorithmic changes to replay rate and erase time is to have the 1000 line sketch to appear as 3 frames, displayed within 600 milliseconds.

In another embodiment, transformation and translation effects are provided. The user can select groups of lines and instruct them to move along a defined path, or expand or contract around a defined point. These transformations may occur at user-defined rates, which would then be played back in the animation. An example of a translation is where each drawn line shifts one pixel to the left with every additional line drawn. This would play back as a scrolling scene. As such, in addition to erasing lines, the system 126 may also gradually move lines from their original position so that space is free for additional drawing. For example, this may occur if the system 126 applies a transformation or translation to the drawing, so that portions of the drawing move gradually off the field of view, or alternatively contract to a small area within the field of view, as the user draws. To achieve this effect, transformations and translations may be applied cumulatively, i.e., lines that have been on the screen the longest are displaced the most.

The pseudo code below outlines an exemplary method for applying a transform and translation to lines (or any drawing event) as they are drawn or replayed. In this example, “Time” is a real variable which represents time, as opposed to being the index of the line (DrawTime in previous examples). Lines may be organized into sets called “layers” that hold information that applies to each line in that set. In addition to several variables that control line thickness, color, and aliasing, layers may contain a set of objects that hold information on how to transform and translate the lines (“Trans.”) Each transform object may contain a real variable that stores the start time “Trans.Starts,” a real variable that stores an end time “Trans.Ends,” and a group of real variables that control transformation and translation: (1) a center variable in the x and y planes (“Trans.C_X” and “Trans.C_Y,”) (2) a translation variable in the x and y planes (“Trans.T_X” and “Trans.T_Y,”) and (3) a multiplication variable in the x and y planes (“Trans.M_X” and “Trans.M_Y.”) In one implementation, the transform variables are ordered so that they occur in start and end times that occur in sequence and do not overlap, i.e., Transform 1 Ends<Transform 2 Starts, Transform 2 Ends<Transform 3 Starts, etc. In addition, rotational transforms may also be performed.

Each line object in the layer may have several associated variables used to control the flow of the program. The line object (“Line”) may contain a boolean drawn variable “Line.Drawn,” a boolean visibility variable “Line.Visible,” a real variable controlling when it should first be displayed (“Line.VisibleAtTime”) and a real variable controlling when the line expires and should be erased (“Line.EraseAtTime.”) Each line variable may also hold an integer variable containing information on how many cumulative transform operations were applied to that line (“Line.Transformed.”) The line variable may also contain the original x and y position (“Line.X” and “Line.Y,”) and the transformed x and y position (“Line.T_X” and “Line.T_Y.”)

In this example, when a line segment is added by the user, the Time variable is incremented by a pre-set amount and the process shown in pseudo code may be applied:

```
  1) For each line in the layer{
  2) set Line.Drawn to true
  3) if ((Line.Visible=true) and (Time>Line.VisibleAtTime) and (Time<
        Line.EraseAtTime)){
  4) set Line.Visible to true
  5) For each Transform in the layer{
    /*determine if the transformation should be applied*/
  6) if ((Time > Transform.Start) and (Time < Transform.End)){
    /*determine how many transform operations to carry out*/
  7) set NumTransforms = Time − Line.Starts − Line.Transformed
    /*calculate the new x and y position*/
  8) For x = 1 to NumTransforms{
  9) set Line.T_X=Trans.M_X(Line.T_X − Trans.C_X)+Trans.T_X
10) set Line.T_Y=Trans.M_Y(Line.T_Y − Trans.C_Y)+Trans.T_Y
        }/*end NumTransforms loop*/
11) set Line.Transformed=Line.Transformed + NumTransforms
    }
    }/*end loop finding the correct transform*/
    }
    }/*end loop for each line in the layer.*/
12) Display all visible transformed lines.
```

In one implementation, the process loops through all the visible lines in the layer (pseudo code lines 1 through 4). The process then finds the transform that is presently active (pseudo code lines 5 and 6). The process then calculates how many transform operations are to be performed on each line object based on how long the line has been visible, and how many times the line has already been transformed (pseudo code line 7). The purpose of the calculation is to help ensure that the transform operation is carried out on each line segment based on how long it has been visible, so that lines that have been visible the longest are transformed the most. The transform operation is then applied to each line segment the correct number of times (pseudo code lines 8, 9 and 10). The number of transform operations applied to each line is then stored (pseudo code line 11). The resulting set of transformed lines are then displayed (pseudocode line 12).

Additional embodiments may provide additional features. Methods and systems in accordance with the present invention are not limited to these embodiments. For example, in one embodiment, methods and systems in accordance with the present invention may provide color filling in which shapes are defined based on the layout of the drawing, as lines define closed polygons in the drawing space. The animation system 126 may fill these polygons with different colors based on a user-defined palette. The animation system 126 may assign colors randomly from this palette or use a user-defined order. If the shapes in the animation gradually change, the color choices can be made consistent to maintain continuity (in this case, the choice would not purely be random).

For example, if the user (or the system) chooses a color that is used to fill a shape, there may be a time when the shape changes so that it no longer defines an enclosed space. For example, consider a closed circle, filled with blue, over a red background. If at a certain time, the circle develops a break, i.e., the circle becomes an arc, and the break is subsequently repaired by the user, it may not make visual sense to color the whole picture blue until the break is repaired. In order to account for this eventuality, the animation system 126 may either query the user to what action should be taken when a closed shape vanishes, or use a heuristic algorithm that assesses whether to draw the colored shape or draw the background color when a line no longer encloses a well-defined area.

In another embodiment, collaboration is provided, and the system functions so that more than one user adds to a single animation at the same time, for example, through two input devices or using two computers 102 and 104 over a network. In this case, the replay rate may be fixed for both users, but each user would define lines with different persistence.

Additionally, in one embodiment, the animation system 126 erases selected lines. The user can select lines and have them erase by causing them to expire in order to aid in the creation of an animation. The system may offer a mode where lines immediately around, e.g., within 10 pixels, the pen expire regardless of their defined persistence as new lines are drawn. Alternatively, the user can select visible lines using the input device, and have them erase. This may be useful in creating animation effects.

Furthermore, in another embodiment, “cut and paste” functions are provided. Animated segments can be selected and inserted into other parts (by translation) of the animation at different time points. This segment can be conceptually thought of as similar to a sprite.

In yet another embodiment, user interaction is facilitated. Areas within the drawing may be defined as buttons or hyperlinks. These areas may become active at defined times, e.g., after a button or link is drawn in, and persist for defined times. This embodiment may then be implemented as a game. For example, the animation may generate buttons which can be pressed, which then trigger events, or switch to different animations, etc. It may also be implemented as a web page, as hyperlinks could link to external HTML documents or other remote information. Another example of user interaction is having the animation pause, zoom, pan or replay based on user input.

Methods and systems in accordance with the present invention may provide additional exemplary uses. For example, in one embodiment, they can be used as animation creation tools to create animations which can be used for entertainment purposes. The output can be translated into different exemplary formats, e.g., images can be saved as an .avi or .mpg files. In another embodiment, the rapidly created animation may be subsequently modified or used by other programs or systems, and possibly rendered using complex techniques.

In one implementation, methods and systems in accordance with the present invention may provide a visual design tool in which the user can load an existing diagram or design, and draw over the design possibly to brainstorm additional ideas. The system may act as a log or journal of visual thoughts and ideas. The segments that most appeal to the user can be developed further. The user can create several branches, or sets of designs from different points in the animation.

In another implementation, the system may be used for drawing instruction. In this case, an experienced artist can create drawings as the system records drawing or paint events. If the expired time is set to be short (that is, a line expires quickly after it is drawn), the animation would display as a short line (or brushstroke) segment that disappears soon after it is drawn. The student would use the system to paint along, setting his or her line duration to a longer interval. The student may then create a static image based on the experienced artist's original.

In yet another implementation, web content creation may be provided. The animation can be made to be interactive, and the animation may define buttons and links that become active, and a viewer can then press to trigger other actions. The animation can then be used as a web page. In an additional implementation, the animation system 126 may be used as an animation creation game. The animation system 126 could potentially allow users to create and send simple animation between devices or save their animation to a computer.

The foregoing description of an implementation in accordance with the present invention has been presented for purposes of illustration and description. It is not exhaustive and is not limited to the precise form disclosed. Modifications and variations are possible in light of the above teachings or may be acquired from practice. For example, the described implementation includes software but the present invention may be implemented as a combination of hardware and software or in hardware alone. Note also that the implementation may vary between systems. Methods and systems in accordance with the present invention may be implemented with both object-oriented and non-object-oriented programming systems.

1. A method in a data processing system, comprising the steps of:
receiving an indication of a drawing event;
assigning a duration to the drawing event;
displaying the drawing event; and
erasing the displayed drawing event after the duration is expired.

2. The method of claim 1, further comprising the step of:
storing the drawing event.

3. The method of claim 1, further comprising the steps of:
receiving one or more indications of one or more other drawings events;
assigning one or more durations to the one or more other drawings events;
displaying the one or more other drawing events; and
erasing the one or more displayed drawing events after the one or more durations have expired.

4. The method of claim 3, wherein the step of displaying further comprises the steps of:
defining a replay rate; and
displaying the drawing events based on the defined replay rate.

5. The method of claim 3, further comprising the step of:
receiving the one or more indications from more than one user.

6. The method of claim 1, wherein the duration comprises a drawing event index.

7. The method of claim 1, wherein the step of assigning a duration further comprises the step of:
assigning the duration in response to a user input.

8. The method of claim 1, wherein the step of assigning a duration further comprises the step of:
assigning the duration by a computer.

9. The method of claim 1, further comprising the step of:
facilitating viewer interaction with the display of the drawing event.

10. The method of claim 1, wherein the indicated drawing event is on an existing drawing, and wherein the step of displaying further comprises the step of:
displaying the drawing event on the existing drawing.

11. The method of claim 1, wherein the step of displaying further comprises the step of:
performing, on the one or more drawing events, one of scaling, panning, zooming, translating and transforming.

12. The method of claim 11, further comprising the step of:
moving one or more drawing events outside of a border of a drawing area.

13. The method of claim 1, further comprising the step of;
moving one or more drawing events to a smaller drawing area.

14. A data processing system, comprising:
a memory comprising a program that receives an indication of a drawing event, assigns a duration to the drawing event, displays the drawing event, and erases the displayed drawing event after the duration is expired; and
a processor for running the program.

15. The data processing system of claim 14, wherein the program further stores the drawing event.

16. The data processing system of claim 14, wherein the program further receives one or more indications of one or more other drawings events, assigns one or more durations to the one or more other drawings events, displays the one or more other drawing events, and erases the one or more displayed drawing events after the one or more durations have expired.

17. The data processing system of claim 16, wherein program further defines a replay rate, and displays the drawing events based on the defined replay rate.

18. The data processing system of claim 16, wherein the program further receives the one or more indications from more than one user.

19. The data processing system of claim 14, wherein the duration comprises a drawing event index.

20. The data processing system of claim 14, wherein program further assigns the duration in response to a user input.

21. The data processing system of claim 14, wherein the program further assigns the duration by a computer.

22. The data processing system of claim 14, wherein the program further facilitates viewer interaction with the display of the drawing event.

23. The data processing system of claim 14, wherein the indicated drawing event is on an existing drawing, and wherein the step of displaying further comprises the step of:
displaying the drawing event on the existing drawing.

24. The data processing system of claim 14, wherein the program further performs, on the one or more drawing events, one of scaling, panning, zooming, translating and transforming.

25. The data processing system of claim 24, wherein the program further moves one or more drawing events outside of a border of a drawing area.

26. The data processing system of claim 14, wherein the program further moves one or more drawing events to a smaller drawing area.

27. A computer-readable medium containing instructions for controlling a data processing system to perform a method comprising the steps of:
receiving an indication of a drawing event;
assigning a duration to the drawing event;
displaying the drawing event; and
erasing the displayed drawing event after the duration is expired.

28. The computer-readable medium of claim 27, wherein the method further comprises the step of:
storing the drawing event.

29. The computer-readable medium of claim 27, wherein the method further comprises the steps of:
receiving one or more indications of one or more other drawings events;
assigning one or more durations to the one or more other drawings events;
displaying the one or more other drawing events; and
erasing the one or more displayed drawing events after the one or more durations have expired.

30. The computer-readable medium of claim 29, wherein the step of displaying further comprises the steps of:
defining a replay rate; and
displaying the drawing events based on the defined replay rate.

31. The computer-readable medium of claim 29, wherein the method further comprises the step of:
receiving the one or more indications from more than one user.

32. The computer-readable medium of claim 27, wherein the duration comprises a drawing event index.

33. The computer-readable medium of claim 27, wherein the step of assigning a duration further comprises the step of:
assigning the duration in response to a user input.

34. The computer-readable medium of claim 27, wherein the step of assigning a duration further comprises the step of:
assigning the duration by a computer.

35. The computer-readable medium of claim 27, wherein the method further comprises the step of:
facilitating viewer interaction with the display of the drawing event.

36. The computer-readable medium of claim 27, wherein the received drawing event is on an existing drawing, and wherein the step of displaying further comprises the step of:
displaying the drawing event on the existing drawing.

37. The computer-readable medium of claim 27, wherein the step of displaying further comprises the step of:
performing, on the one or more drawing events, one of scaling, panning, zooming, translating and transforming.

38. The computer-readable medium of claim 27, wherein the method further comprises the step of:
moving one or more drawing events outside of a border of a drawing area.

39. The computer-readable medium of claim 27, wherein the method further comprises the step of:
moving one or more drawing events to a smaller drawing area.

40. A data processing system comprising:
means for receiving an indication of a drawing event;
means for assigning a duration to the drawing event;
means for displaying the drawing event; and
means for erasing the displayed drawing event after the duration is expired.
